(19) United States
(12) Patent Application Publication
(10) Pub. No.: US 2005/0275197 A1
(43) Pub. Date: Dec. 15, 2005

(54) Airbag cover and airbag system

(75) Inventors: Masahiko Kaifuki, Aki-gun (JP); Kei Tsujimoto, Hikone-shi (JP); Yoshitaka Matsui, Kanzaki-gun (JP); Wataru Nakazawa, Higashiomi-shi (JP)

Correspondence Address: FOLEY AND LARDNER LLP;SUITE 500, 3000 K STREET NW, WASHINGTON, DC, 20007, US

(73) Assignee: TAKATA CORPORATION

(21) Appl. No.: 11/136,391

(22) Filed: May 25, 2005

(30) Foreign Application Priority Data
Jun. 15, 2004 (JP) 2004-177581

(51) Int. Cl. B60R 21/20

(52) U.S. Cl. 280/728.3

(57) ABSTRACT

An airbag cover of an airbag system has a flat surface extending in such a way as to face the occupant, a rising wall rising from the back of the airbag-cover flat surface toward a mount portion on the vehicle side and fixed to the mount portion, and a tear line formed in the airbag-cover flat surface and the rising wall, wherein when the vehicle airbag inflates, the airbag cover is cleaved along the tear line in the airbag-cover flat surface and the rising wall to be divided into airbag-cover divided pieces and is opened around the hinge of the rising wall.

### BACKGROUND

The present invention relates to a cover and the associated technique of the cover for a vehicle airbag.

Airbag systems mounted to vehicles are typically provided with an airbag cover for covering the occupant side of a vehicle airbag. The airbag cover has a tear line (a linear groove) in its inner wall surface. In the event of a vehicle collision, the airbag cover is torn open along the tear line to allow deployment of the vehicle airbag to the exterior of the airbag cover.

Japanese Unexamined Patent Application Publication No. 2000-38107 (incorporated by reference herein) describes the structure of an airbag cover mounted to a steering wheel that incorporates an airbag system. The airbag cover is torn open along a tear line (breaking part) formed in the flat surface of the cover by the inflating force of the vehicle airbag in a vehicle accident. Japanese Unexamined Patent Application Publication No. 2000-38107 (incorporated by reference herein) presents a possibility of preventing the interference between the opened airbag cover and the occupant of the vehicle by designing the shape of the tear line formed in the airbag cover. However, the airbag cover of this type requires an increase in occupant restraining performance in an accident with a structure that allows smooth deployment of the vehicle airbag.

### SUMMARY

It is an object of an embodiment of the present invention to provide a technique of constructing an airbag cover for covering the occupant side of a vehicle airbag that is effective in increasing occupant restraining performance in an accident.

According to an embodiment of the present invention, an airbag cover for covering a vehicle airbag includes an airbag cover flat surface that faces a vehicle occupant, a rising wall that rises from the back of the airbag cover flat surface toward a mount portion on a vehicle side of the airbag cover, wherein the rising wall is adapted to be fixed to the mount portion, a tear line for cleaving the airbag cover that is formed on the airbag-cover flat surface and the rising wall, and a hinge that is formed on the rising wall, wherein when the vehicle airbag is deployed, the airbag cover is cleaved along at least a portion of the tear line on the airbag-cover flat surface and on at least a portion of the tear line on the rising wall, causing the airbag cover to be divided into at least three airbag cover divided pieces and wherein the airbag cover is opened around the hinge of the rising wall.

According to another embodiment of the present invention, an airbag system for a vehicle includes a vehicle airbag, an airbag cover for covering the occupant side of the vehicle airbag, a retainer on the vehicle side for accommodating the vehicle airbag, and an inflator, wherein the airbag cover comprises: an airbag-cover flat surface extending in such a way as to face the occupant; a rising wall rising from the back of the airbag-cover flat surface toward the mount portion of the vehicle and fixed to the retainer; a tear line for cleaving the airbag cover, formed in the airbag-cover flat surface and the rising wall; and a hinge formed on the rising wall, wherein when the vehicle airbag is deployed into an occupant protection region by the inflation gas supplied from the inflator in a vehicle collision, the airbag cover is cleaved along the tear line in the airbag-cover flat surface and the rising wall to be divided into at least three airbag-cover divided pieces and is opened around the hinge of the rising wall.

It is to be understood that both the foregoing general description and the following detailed description are exemplary and explanatory only, and are not restrictive of the invention as claimed.

### BRIEF DESCRIPTION OF THE DRAWINGS

These and other features, aspects, and advantages of the present invention will become apparent from the following description, appended claims, and the accompanying exemplary embodiments shown in the drawings, which are briefly described below.

FIG. 1 is a view of an airbag system according to an embodiment of the present invention.

FIG. 2 is a view of an airbag system in an open state according to an embodiment of the present invention.

FIG. 3 is a plan view of an airbag cover according to an embodiment of the present invention.

FIG. 4 is a sectional view of an airbag system according to an embodiment of the present invention.

FIG. 5 is a sectional view of an airbag system in an open state according to an embodiment of the present invention.

### DETAILED DESCRIPTION

Embodiments of the present invention will be described below with reference to the drawings.

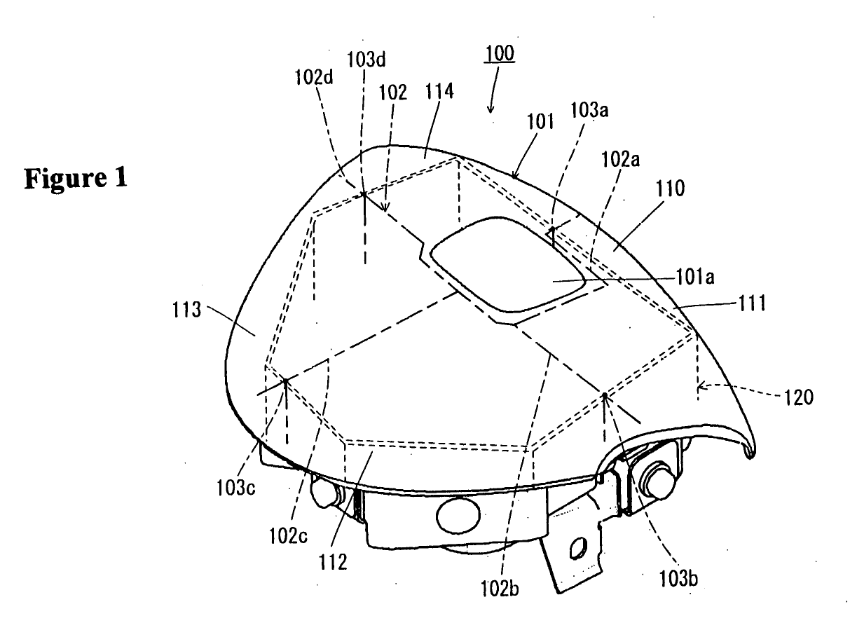

The structure of an airbag system 100 according to an embodiment of the invention will first be described with reference to FIGS. 1 to 4. The airbag system 100 may be mounted to the steering wheel of a car.

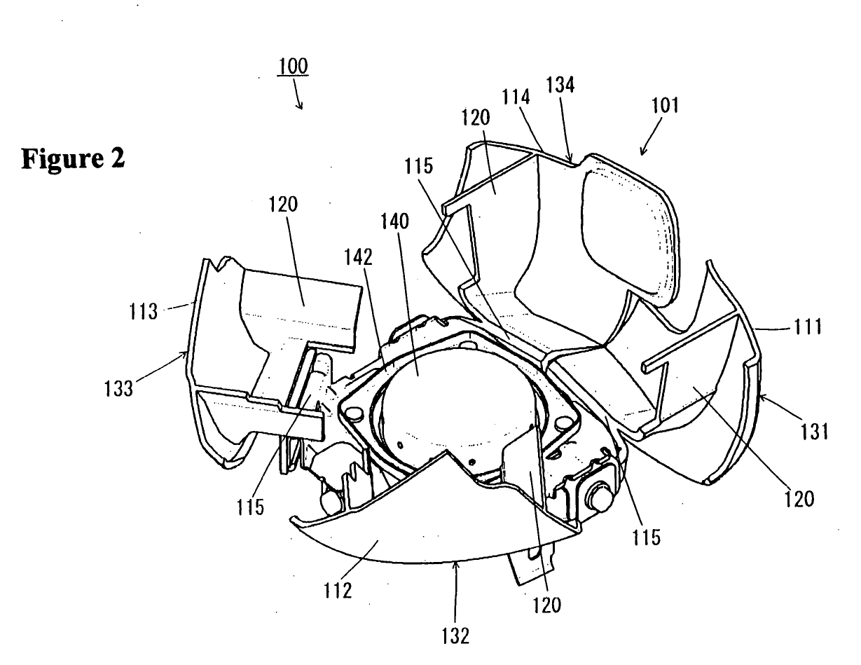

As shown in FIGS. 1 and 2, the airbag system 100 may be composed principally of a vehicle airbag (a vehicle airbag 144, to be described later), a retainer 142 in which the vehicle airbag is accommodated in a folded state, an inflator 140 built in the retainer 142, for supplying inflation gas to the vehicle airbag, and the airbag cover 101 for covering the occupant side of the vehicle airbag in a folded state. In a vehicle accident, the inflator 140 is activated, so that the vehicle airbag is deployed by the inflation gas supplied from the inflator 140. At that time, the airbag cover 101 is torn open along a tear line 102 by the inflating force of the vehicle airbag to allow the deployment of the vehicle airbag into an occupant protection region.

The airbag cover 101 shown in the example of FIG. 1 has a solid three-dimensional plate-like structure made of a resin material such as a polypropylene (PP) material or an olefinic elastomer (TPO) material. The airbag cover 101 may be an airbag cover for covering the occupant side of the vehicle airbag and may have an airbag-cover flat surface 110, a rising wall 120, and a tear line 102, as shown in FIG. 1.

Of the parts of the airbag cover 101, the airbag-cover flat surface 110 constructs a flat surface extending so as to face the occupant of the vehicle and extends to the occupant side of the vehicle airbag in a folded state. In about the center of the airbag-cover flat surface 110, an emblem 101a is provided which allows identification of the vehicle manufacturer and the type of vehicle.

Of the parts of the airbag cover 101, the rising wall 120 is a part rising from the back of the airbag-cover flat surface 110 toward the retainer 142 to which the airbag cover 101 is attached, and rises around the outer periphery of the vehicle airbag in a folded state. FIG. 1 shows the rising wall 120 rising from the back of the airbag-cover flat surface 110 by broken lines. The back of the airbag-cover flat surface 110 is defined as a back surface in the case where the side facing the occupant is a front surface, with the airbag cover 101 mounted.

The tear line 102 may be a part with a reduced thickness for allowing the airbag cover 101 to be cleaved at the inflation of the vehicle airbag. In an embodiment of the current invention, the tear line 102 may be a linear groove formed in the back of the airbag-cover flat surface 110. The tear line 102 is indicated by alternate long and short dashed lines in the example of FIG. 1. The tear line 102 may be formed by ultrasonic machining or laser machining. The tear line 102 may be constructed of multiple tear-line extensions extending radially from the central region of the airbag cover 101, in which the emblem 101a is provided, toward the outer periphery of the airbag cover 101. The tear line 102 may correspond to part or all of the cleaving line which is actually cleaved along the tear line 102.

In an embodiment of the present invention, the tear line 102 may be roughly divided into four tear-line extensions of a first tear-line extension 102a, a second tear-line extension 102b, a third tear-line extension 102c, and a fourth tear-line extension 102d. The airbag-cover flat surface 110 may be segmented into four airbag-cover flat surfaces of a first airbag-cover flat surface 111, a second airbag-cover flat surface 112, a third airbag-cover flat surface 113, and a fourth airbag-cover flat surface 114.

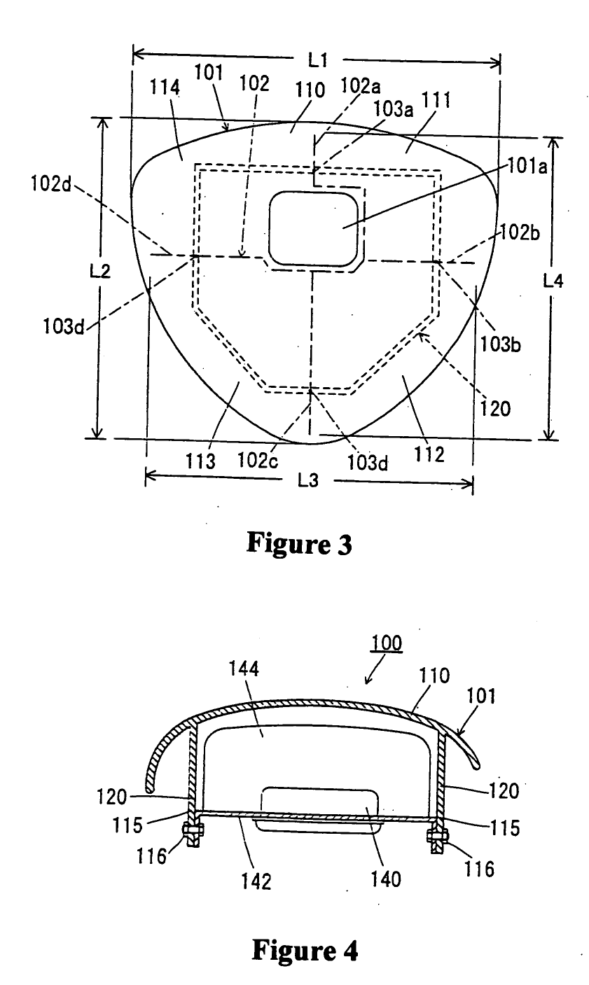

As shown in FIG. 3, the first tear-line extension 102a may extend from the central region of the airbag cover 101 toward the upper side of FIG. 3 (hereinafter, referred to as a twelve o'clock direction) such that it avoids the emblem 101a. The first tear-line extension 102a may extend from the central region of the airbag cover 101 to a position immediately in front of the outer periphery of the airbag cover 101 toward the outer periphery of the airbag cover 101 on the upper side of the vehicle. The second tear-line extension 102b may extend from the central region to a position immediately in front of the outer periphery of the airbag cover 101 toward the right side in FIG. 3 (hereinafter, referred to as a three o'clock direction). The third tear-line extension 102c may extend from the central region to a position immediately in front of the outer periphery of the airbag cover 101 toward the lower side in FIG. 3 (hereinafter, referred to as a six o'clock direction). The fourth tear-line extension 102d may extend from the central region to a position immediately in front of the outer periphery of the airbag cover 101 toward the left side in FIG. 3 (hereinafter, referred to as a nine o'clock direction).

The length of the extension (extending dimension) of the tear line 102 in the airbag-cover flat surface 110 may be set as appropriate depending on the size of the airbag cover 101 in plan view. In an embodiment of the present invention, relational expressions may be used to relate the lengths of the airbag cover and the tear lines. For example, L3≧0.6×L1 and L4≧0.6×L2 hold, where L1 is the maximum lateral length (the lateral length in FIG. 3) of the airbag cover 101, L2 is the maximum longitudinal length (the vertical length in FIG. 3) of the airbag cover 101, L3 is the lateral length (the lateral length in FIG. 3) of the tear line 102, and L4 is the longitudinal length (the vertical length in FIG. 3) of the tear line 102. In this example, the portion corresponding to the lateral length L3 of the tear line 102 is composed of the second tear-line extension 102b and the fourth tear-line extension 102d, and the portion corresponding to the longitudinal length L4 of the tear line 102 is composed of the first tear-line extension 102a and the third tear-line extension 102c. This relation allows the airbag cover 101 to be cleaved smoothly along the tear line 102, thus further ensuring the operation of widely opening the entire airbag cover 101.

According to the embodiment, each of the first to fourth tear-line extensions 102a, 102b, 102c, and 102d that construct the tear line 102 extends toward the outer periphery of the airbag-cover flat surface 110 and also extends along the inner peripheral wall or the outer peripheral wall of the rising wall 120 toward the lower end of the rising wall 120. For example, the first to fourth tear-line extensions 102a, 102b, 102c, and 102d branch off at intersections 103a, 103b, 103c, and 103d at which the airbag-cover flat surface 110 intersects the rising wall 120 and extend toward the lower end of the rising wall 120. The state in which the first to fourth tear-line extensions 102a, 102b, 102c, and 102d extend from the intersections 103a, 103b, 103c, and 103d toward the lower end of the rising wall 120 is schematically shown in FIG. 1.

In the example shown in FIG. 4, the airbag cover 101 covers the occupant side (the upper side of FIG. 4) of the vehicle airbag 144 in a folded state, and the end of the rising wall 120 is fixed to the retainer 142 with a fixing means 116, such as a bolt, provided in the vicinity of the horizontal plane of the retainer 142 being attached. Here the end of the rising wall 120 is defined as the other end, with the back of the airbag-cover flat surface 110 as the base end of the rising wall 120. Thus, the end of the rising wall 120 is provided with a hinge 115 serving as the fulcrum of the opening operation of the airbag cover 101 in the vicinity of the horizontal surface of the retainer 142.

The airbag cover 101 with the above structure may be cleaved along the tear line 102 (the tear-line extensions 102a, 102b, 102c, and 102d) formed in the airbag-cover flat surface 110 and the rising wall 120 by the deploying force of the vehicle airbag. At that time, the airbag-cover flat surface 110 of the airbag cover 101 may be cleaved along the tear line 102 to the outer periphery of the airbag-cover flat surface 110, while the rising wall 120 of the airbag cover 101 may be cleaved along the tear line 102 to the end (the lower end) of the rising wall 120. Thus, in this embodiment, the cleaving line is formed over the tear line 102.

In the example shown in FIG. 2, the airbag cover 101 may be divided into four airbag-cover divided pieces (opening doors) of a first airbag-cover divided piece 131, a second airbag-cover divided piece 132, a third airbag-cover divided piece 133, and a fourth airbag-cover divided piece 134. The first airbag-cover divided piece 131 may be composed of a first airbag-cover flat surface 111 and the part of the rising wall 120 which connects with the first airbag-cover flat surface 111. The second airbag-cover divided piece 132 may be composed of a second airbag-cover flat surface 112 and the part of the rising wall 120 which connects with the second airbag-cover flat surface 112. The third airbag-cover divided piece 133 may be composed of a third airbag-cover flat surface 113 and the part of the rising wall 120 which connects with the third airbag-cover flat surface 113. The fourth airbag-cover divided piece 134 may be composed of a fourth airbag-cover flat surface 114 and the part of the rising wall 120 which connects with the fourth airbag-cover flat surface 114.

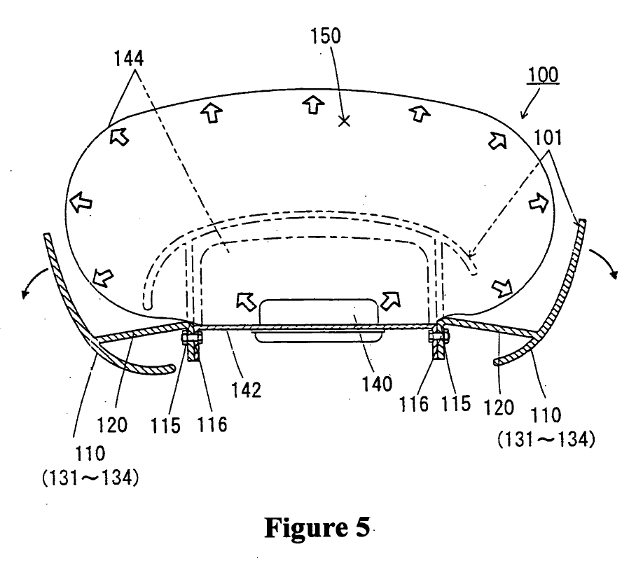

In the example shown in FIG. 5, the divided first to fourth airbag-cover divided pieces 131, 132, 133, and 134 may be opened while turning radially around the inflator 140 outwards (in the direction of the arrows) with the hinge 115 as the fulcrum. This allows the deployment of the vehicle airbag 144 into an occupant protection region 150. Thus, the vehicle airbag 144 deploys through the opened airbag cover 101 to the exterior thereof into the occupant protection region 150. In FIG. 5, the states of the vehicle airbag 144 and the airbag cover 101 during the operation of the airbag system 100 are indicated by solid lines; those before the operation of the airbag system 100 are indicated by alternate long and two short dashed lines.

In the embodiment shown in FIG. 5, the entire airbag cover 101 is torn open along the tear line 102 to the outer periphery of the airbag-cover flat surface 110 and the end (the lower end) of the rising wall 120, and at the time of opening the hinge 115 is located in the position of the horizontal surface of the retainer 142. Accordingly, the entire airbag cover 101 is opened widely from the base to the outer periphery. This increases the cover opening area that allows the deployment of the vehicle airbag 144 into the occupant protection region 150 and also allows a three-dimensional space for deployment to be formed rapidly, not only to the occupant side of the vehicle airbag 144 but also to the outer periphery. Thus, the vehicle airbag 144 may be deployed in a short time and in a three-dimensional wide range. This ensures the deployment of the vehicle airbag 144 along the length and width of the vehicle in the occupant protection region 150 while reducing the time required to inflate the vehicle airbag 144 (or increasing the inflating speed of the vehicle airbag 144), thus improving occupant restraining performance in an accident.

Further, by the opening motion of the entire airbag cover 101 from the base to the outer periphery, the motion of the airbag-cover divided pieces 131 to 134 toward the occupant side can be restrained and interference of the airbag-cover divided pieces 131, 132, 133, and 134 with the occupant may be prevented. This allows further protection of occupants in a vehicle accident.

According to an embodiment of the present invention, the tear line 102 may be constructed of the tear-line extensions 102a, 102b, 102c, and 102d which extend radially from the central region of the airbag cover 101 toward the outer periphery in the airbag-cover flat surface 110. Accordingly, the three-dimensional space that allows the deployment of the vehicle airbag 144 into the occupant protection region 150 may be increased in the radial direction from the central region of the airbag cover 101 to the outer periphery, thus further ensuring the deployment of the vehicle airbag 144 along the length and width of the vehicle in the occupant protection region 150.

In a further embodiment of the present invention, the tear line 102 may be constructed of the tear-line extension 102a which extends radially from the central region of the airbag cover 101 toward the upper outer periphery in the airbag-cover flat surface 110. Thus, the airbag-cover divided pieces 131 and 134 which are divided laterally from the central region of the airbag cover 101 along the tear-line extension 102a may be prevented from moving closer to the occupant. This embodiment is constructed such that the hinge 115 may be provided at the end of the rising wall 120 and the airbag cover 101 may be opened around the hinge 115 which may be provided in a position apart from the airbag-cover flat surface 110 as much as possible. Accordingly, the entire airbag cover 101 may be opened widely from the base toward the outer periphery, with the motion of the airbag-cover divided pieces 131 to 134 toward the occupant restrained more surely.

Further, by the opening motion of the entire airbag cover 101 from the base to the outer periphery in the embodiment, an emblem 101a that is provided at or near the center of the airbag-cover flat surface 110 may be separated from the vehicle airbag 144 and the occupant when the airbag cover 101 is torn open along the tear line 102.

Although the above embodiment has been described with reference to the airbag cover 101 with a structure in which it is divided into four airbag-cover divided pieces of first to fourth airbag-cover divided pieces 131, 132, 133, and 134, the number of airbag-cover divided pieces may be set within the range of three or more as appropriate.

The airbag cover of the present invention may also serve the function as a portion to be pressurized to operate a horn in addition to the function of covering a vehicle airbag.

Although the above embodiment has been described with reference to a driver airbag system to be mounted to a steering wheel, the invention may also be applied to the structure of an airbag cover of a passenger airbag system, for example. In the passenger airbag system, the airbag cover of the invention constructs part of an instrument panel.

Although the above embodiment has been described with reference to a car airbag system, the invention is applicable to the structure of airbag systems mounted in vehicles other than cars, such as motorcycles (saddle-type vehicles), aircraft, ships, vessels, and trains.

The priority application JP2004-177581, filed Jun. 15, 2004 is incorporated by reference herein.

Given the disclosure of the present invention, one versed in the art would appreciate that there may be other embodiments and modifications within the scope and spirit of the invention. Accordingly, all modifications attainable by one versed in the art from the present disclosure within the scope and spirit of the present invention are to be included as further embodiments of the present invention. The scope of the present invention is to be defined as set forth in the following claims.

1. An airbag cover for covering a vehicle airbag, comprising:
a flat surface that faces a vehicle occupant;
a rising wall that rises from the back of the flat surface toward a mount portion on a vehicle side of the airbag cover, wherein the rising wall is adapted to be fixed to the mount portion;
a tear line for cleaving the airbag cover that is formed on the flat surface and the rising wall; and
a hinge that is formed on the rising wall;
wherein when the vehicle airbag is deployed, the airbag cover is cleaved along at least a portion of the tear line on the flat surface and on at least a portion of the tear line on the rising wall, causing the airbag cover to be divided into at least three airbag cover divided pieces and wherein the airbag cover is opened around the hinge of the rising wall.

2. The airbag cover according to claim 1, wherein the tear line includes a plurality of tear-line extensions on the flat surface, wherein the extensions extend radially from a central region of the airbag cover toward an outer periphery of the airbag cover.

3. The airbag cover according to claim 2, wherein the tear line extensions form an intersection with the tear line on the rising wall and the tear line extensions further extend radially beyond the intersection to the outer periphery of the airbag cover.

4. The airbag cover according to claim 1, wherein the tear line includes a tear-line extension on the flat surface, the extension extending from a central region of the airbag cover toward an upper outer periphery of the airbag cover.

5. The airbag cover according to claim 1, wherein the hinge is located at an end of the rising wall.

6. The airbag cover according to claim 1, wherein the airbag cover is divided into at least four airbag cover divided pieces.

7. The airbag cover according to claim 1, wherein the airbag cover is adapted to be used with a driver side airbag module.

8. The airbag cover according to claim 1, wherein the airbag cover is adapted to be used with a passenger side airbag module.

9. The airbag cover according to claim 1, wherein lengths of the airbag cover and the tear lines are related by:
L3≧0.6×L1
L4≧0.6×L2
wherein L1 is a maximum lateral length of the airbag cover, L2 is the maximum longitudinal length of the airbag cover, L3 is the lateral length of the tear line, and L4 is the longitudinal length of the tear line.

10. An airbag system for a vehicle, comprising:
a vehicle airbag;
an airbag cover for covering the occupant side of the vehicle airbag;
a retainer on the vehicle side for accommodating the vehicle airbag; and
an inflator;
wherein the airbag cover comprises a flat surface extending in such a way as to face the occupant; a rising wall rising from the back of the flat surface toward the mount portion of the vehicle and fixed to the retainer; a tear line for cleaving the airbag cover, formed in the flat surface and the rising wall; and a hinge formed on the rising wall;
wherein when the vehicle airbag is deployed into an occupant protection region by the inflation gas supplied from the inflator in a vehicle collision, the airbag cover is cleaved along the tear line in the flat surface and the rising wall to be divided into at least three airbag-cover divided pieces and is opened around the hinge of the rising wall.

11. The airbag system according to claim 10, wherein the tear line includes a plurality of tear-line extensions on the flat surface, wherein the extensions extend radially from a central region of the airbag cover toward an outer periphery of the airbag cover.

12. The airbag system according to claim 11, wherein the tear line extensions form an intersection with the tear line on the rising wall and the tear line extensions further extend radially beyond the intersection to the outer periphery of the airbag cover.

13. The airbag system according to claim 10, wherein the hinge is located at an end of the rising wall.

14. The airbag system according to claim 10, wherein the airbag cover is divided into at least four airbag cover divided pieces.

15. The airbag system according to claim 10, wherein the airbag system is adapted to be used on the driver side of the vehicle.

16. The airbag system according to claim 10, wherein the airbag system is adapted to be used on the passenger side of the vehicle.

17. The airbag system according to claim 10, wherein lengths of the airbag cover and the tear lines are related by:
L3≧0.6×L1
L4≧0.6×L2
wherein L1 is a maximum lateral length of the airbag cover, L2 is the maximum longitudinal length of the airbag cover, L3 is the lateral length of the tear line, and L4 is the longitudinal length of the tear line.

18. The airbag system according to claim 10, wherein the tear line includes a tear-line extension on the flat surface, the extension extending from a central region of the airbag cover toward an upper outer periphery of the airbag cover.
